(19) United States
(12) Patent Application Publication
(10) Pub. No.: US 2023/0180724 A1
(43) Pub. Date: Jun. 15, 2023

(54) Controllable Semi-Open Mariculture Cabin System

(71) Applicant: GUANGDONG OCEAN UNIVERSITY, Zhanjiang (CN)

(72) Inventors: Guoyan YU, Zhanjiang (CN); Zhenyi YANG, Zhanjiang (CN)

(73) Assignee: Guangdong Ocean University, Zhanjiang (CN)

(21) Appl. No.: 17/767,012

(22) PCT Filed: Nov. 16, 2020
(86) PCT No.: PCT/CN2020/128968

§ 371 Date: Apr. 6, 2022

(51) Int. Cl. A01K 63/04

(52) U.S. Cl. CPC A01K 63/045

(57) ABSTRACT

A controllable semi-open mariculture cabin system is provided, including a mariculture cabin, a water inlet mechanism, a filtering mechanism, and a fish outlet pipe. The water inlet mechanism includes a water inlet pipe and a plurality of high-pressure water inlet pipes. The water inlet pipe is located on one side of an upper part of the mariculture cabin. The plurality of high-pressure water inlet pipes are distributed in a circumferential direction of a top of the mariculture cabin. Tail ends of the high-pressure water inlet pipes are connected to jet pipes extending into the mariculture cabin. The filtering mechanism is arranged at the bottom of the mariculture cabin. An outlet end of the filtering mechanism is located in sea water outside. The fish outlet pipe is provided on a cabin wall of the mariculture cabin. A gate valve capable of opening and closing is mounted on the fish outlet pipe.

### CROSS REFERENCE TO RELATED APPLICATION

This patent application is a national stage application of International Patent Application No. PCT/CN2020/128968, filed on Nov. 16, 2020, the disclosure of which is incorporated by reference herein in its entirety.

### TECHNICAL FIELD

This disclosure relates to the technical field of deep sea fisheries, and in particular, to a controllable semi-open mariculture cabin system.

### BACKGROUND

With continuous development of society and economy, coastal marine environmental pollution is aggravated, the benefit of a traditional mariculture mode is decreased, and the diseases of mariculture species are serious. Under the background of increasing rigid constraints on resources and environment, how to improve the mariculture density and the yield per unit water and reduce mariculture environmental pollution has become an urgent problem to be solved. The current development direction is to expand an open sea mariculture space and vigorously develop three-dimensional culture in marine ranching and mariculture in a net cage in open sea deepwater as key tasks. Coordinating the development of marine fishery resources, supporting intensive healthy mariculture, optimizing the spatial layout of mariculture, and exploring and developing an environment-friendly and healthy mariculture mode have become the only way for the sustainable and efficient development of the mariculture industry.

As a novel marine operation platform and mariculture mode, a deep sea mariculture ship has been widely concerned in the field of marine engineering and mariculture industry. Through autonomous navigation, the deep sea mariculture ship searches for the best quality water source and the best mariculture water temperature environment, which can not only avoid the influence of natural disasters, such as typhoon and red tide, but also effectively avoid the pollution of offshore mariculture and the risk of deep sea mariculture, thereby achieving efficient production throughout the seasons and ensure the supply of high-quality aquatic products. At present, there are two main mariculture modes: one is to use closed circulating water mariculture; and the second is to use fully open mariculture. The former needs to be equipped with a special closed circulating water treatment system and is represented by Lulan Fishing Culture 61699 designed by Ocean University of China and Fishery Machinery and Instrument Research Institute, Chinese Academy of Fishery Sciences, which has high system construction cost and operation cost. For the latter, the mariculture net cages are completely placed in a sea area, and water exchange is performed by completely using the seawater flowing in the sea area where the mariculture net cages are located without any water treatment. A large-scale deep sea mariculture factory ship designed by NSK Ship Design Corporation of Norway belongs to a fully open mariculture mode, but the mariculture environment also completely depends on the sea area where the mariculture net cages are located, which basically belongs to a traditional mariculture mode.

### SUMMARY

An objective of the present disclosure is to provide a controllable semi-open mariculture cabin system to solve the above-mentioned problems in the prior art, which can effectively reduce the high energy consumption required by the operation of a closed circulating mariculture system, and effectively reduce the damage to the marine environment caused by pollutants produced by open mariculture.

To achieve the above-mentioned objective, the present disclosure provides the following technical solution: the present disclosure provides a controllable semi-open mariculture cabin system, including a mariculture cabin, a water inlet mechanism, a filtering mechanism, and a fish outlet pipe. The water inlet mechanism includes a water inlet pipe and a plurality of high-pressure water inlet pipes. The water inlet pipe is located on one side of an upper part of the mariculture cabin. The plurality of high-pressure water inlet pipes are distributed in a circumferential direction of a top of the mariculture cabin. Tail ends of the high-pressure water inlet pipes are connected to jet pipes extending into the mariculture cabin. The filtering mechanism is arranged at a bottom of the mariculture cabin. An outlet end of the filtering mechanism is located in sea water outside. The fish outlet pipe is provided on a cabin wall of the mariculture cabin. A gate valve capable of opening and closing is mounted on the fish outlet pipe.

In some embodiments, a water pump is provided on the water inlet pipe, and the water pump is used for pumping a water source.

In some embodiments, water pumps are also mounted on the high-pressure water inlet pipes. The jet pipes are arranged downward vertically along an inner wall of the mariculture cabin. Jet holes are uniformly distributed in the jet pipes.

In some embodiments, the filtering mechanism includes a frustoconical fine filter screen and an annular sewage sump. The annular sewage sump is provided in an outer circumference of a bottom of the frustoconical fine filter screen. A sewage outlet of the annular sewage sump is communicated with a sewage pipeline.

In some embodiments, a coarse filter screen is mounted at an opening of an upper part of the annular sewage sump. A filtering diameter of the coarse filter screen is greater than that of the frustoconical fine filter screen.

In some embodiments, a tail end of the sewage pipeline extends out of the mariculture cabin and is connected to a solid-liquid separator. A conveying pump is provided on the sewage pipeline.

In some embodiments, the solid-liquid separator is provided with a solid outlet and a liquid outlet. Separated solid waste is discharged from the solid outlet, and water is discharged from the liquid outlet.

In some embodiments, an overflow pipe is provided at an inlet of the solid-liquid separator, and another end (i.e. outlet end) of the overflow pipe is communicated with the annular sewage sump.

Compared with the prior art, the present disclosure achieves the following beneficial technical effects:

The controllable semi-open mariculture cabin system in the present disclosure provides the best mariculture and growth environment for valuable fish by using the marine self-purification capacity of deep sea and the flow field controllable capacity of the mariculture cabin on the premise of not damaging the marine environment, which effectively reduces the high energy consumption required by the operation of the closed circulating mariculture system, and effectively reduces the damage to the marine environment caused by the pollutants produced by open mariculture.

### BRIEF DESCRIPTION OF THE DRAWINGS

To describe the technical solutions in the embodiments of the present disclosure or in the prior art more clearly, the following briefly describes the accompanying drawings required for describing the embodiments. Apparently, the accompanying drawings in the following description are merely some embodiments of the present disclosure, and those of ordinary skill in the art may still derive other drawings from these accompanying drawings without creative efforts.

FIG. 1 is a schematic diagram of an overall structure of a controllable semi-open mariculture cabin system.

FIG. 2 is a schematic diagram of the installation of a frustoconical fine filter screen and an annular sewage sump.

FIG. 3 is a structural diagram of a fish outlet pipe.

FIG. 4 is a schematic diagram 1 of the connection of a sewage pipeline, a solid-liquid separator, and an overflow pipe.

FIG. 5 is a schematic diagram 2 of the connection of the sewage pipeline, the solid-liquid separator, and the overflow pipe.

### DETAILED DESCRIPTION

Technical solutions in the embodiments of the present disclosure will be clearly and completely described herein below with reference to the drawings in the embodiments of the present disclosure. The described embodiments are merely part rather than all of the embodiments of the present disclosure. On the basis of the embodiments of the present disclosure, all other embodiments obtained by those of ordinary skill in the art without creative work fall within the scope of protection of the present disclosure.

An objective of the present disclosure is to provide a controllable semi-open mariculture cabin system to solve the above-mentioned problems in the prior art, which can effectively reduce the high energy consumption required by the operation of a closed circulating mariculture system, and effectively reduce the damage to the marine environment caused by pollutants produced by open mariculture.

In order to make the abovementioned objective, features, and advantages of the present disclosure more apparent and more comprehensible, the present disclosure is further described in detail below with reference to the drawings and specific implementation manners. Reference signs in the drawings include: 1 high-pressure water inlet pipe, 2 jet pipe, 3 frustoconical fine filter screen, 4 annular sewage sump, 5 sewage pipeline, 6 overflow pipe, 7 conveying pump, 8 solid-liquid separator, 9 solid outlet, 10 liquid outlet, 11 mariculture cabin, 12 gate valve, 13 fish outlet, and 14 water inlet pipe.

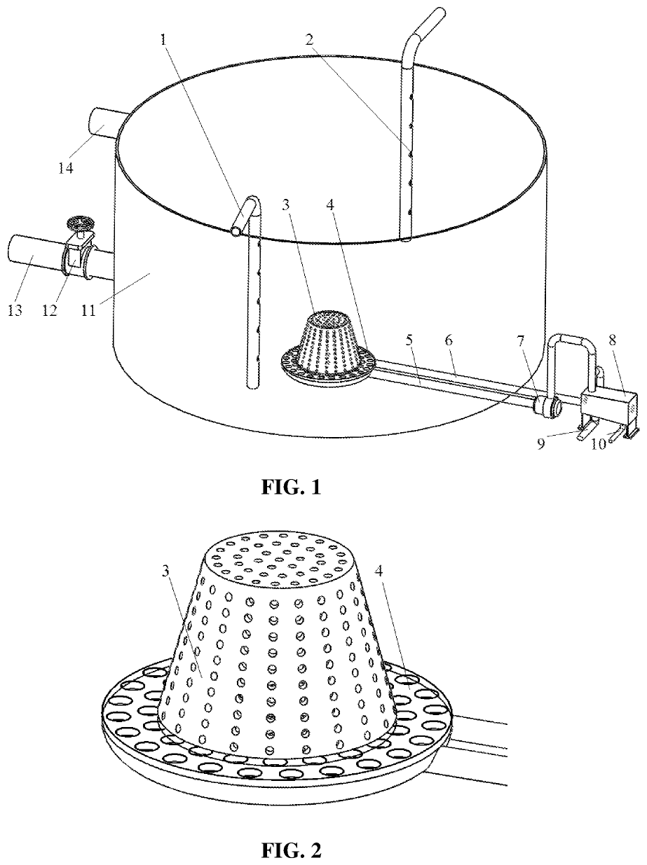

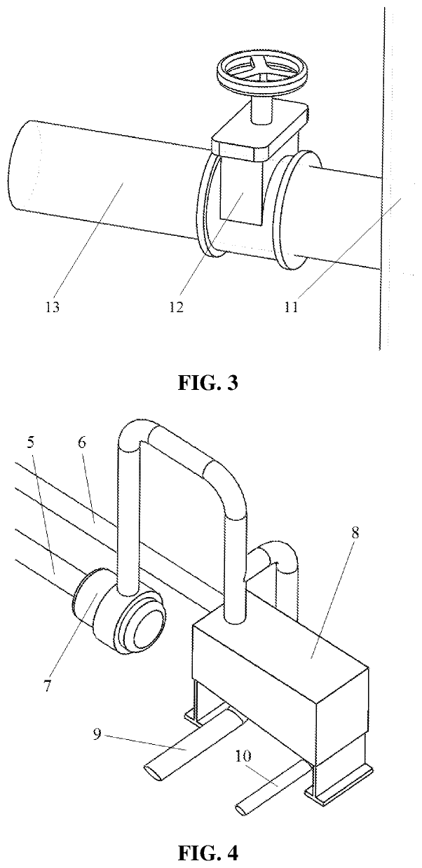

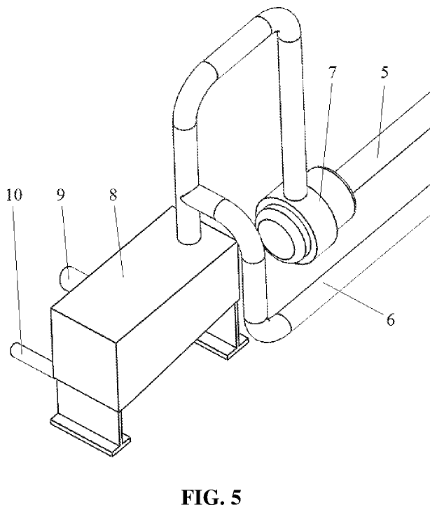

As shown in FIGS. 1 to 5, the present embodiment provides a controllable semi-open mariculture cabin system, including a mariculture cabin 11, a water inlet mechanism, a filtering mechanism, and a fish outlet pipe 13. The water inlet mechanism includes a water inlet pipe 14 and a plurality of high-pressure water inlet pipes 1. The water inlet pipe 14 is located on one side of the upper part of the mariculture cabin 11. The plurality of high-pressure water inlet pipes 1 are distributed in the circumferential direction of the top of the mariculture cabin 11. The tail ends of the high-pressure water inlet pipe 1 are connected to jet pipes 2 extending into the mariculture cabin 11. The filtering mechanism is provided at the bottom of the mariculture cabin 11. An outlet end of the filtering mechanism is located in sea water outside. The fish outlet pipe 13 is provided on the cabin wall of the mariculture cabin 11. A gate valve 12 capable of opening and closing is mounted on the fish outlet pipe 13.

The water inlet pipe 14 provides a water source matrix for the mariculture cabin 11. The high-pressure water inlet pipes 1 provide pressurized water for the jet pipes 2. The jet pipes 2 provide energy for establishing a flow field inside the mariculture cabin 11 and control the flow rate, which is suitable for fish growth. With the filtering mechanism arranged at the bottom of the mariculture cabin 11, the wastes in the mariculture cabin 11 are filtered and discharged, and then flows into the sea water. When the gate valve 12 on the fish outlet pipe 13 is open, adult fish enters the fish outlet pipe 13 along with a water flow, the fish outlet pipe 13 is a fishing channel, and the gate valve 12 controls the fish outlet pipe 13 to open and close.

In the present embodiment, the water inlet pipe 14 and the jet pipes 2 are mounted around the wall surface of the mariculture cabin 11. A water pump is provided on the water inlet pipe 14, and is used for pumping a water source. Water pumps are also mounted on the high-pressure water inlet pipes 1. The jet pipes 2 are arranged downward vertically along the inner wall of the mariculture cabin 11. Jet holes are uniformly distributed in the jet pipes 2. The water inlet pipe 14 provides water for the mariculture cabin 11, and the jet pipes 2 control a flow direction, which is suitable for fish growth. The jet pipes 2 provide energy for the flow field inside the mariculture cabin 11. An angle of orifice of each jet pipe 2 controls a direction of water flow.

In the present embodiment, an inverted frustoconical fine filter screen 3 is mounted at the bottom of the mariculture cabin 11. An annular sewage sump 4 is formed in the edge of the lower part of the filter screen. A coarse filter screen is mounted at the upper part of the annular sewage sump 4 (for preventing fish from entering a sewage system). The water flowing in the cabin performs water exchange with an ocean through fine meshes of the filter mesh. When wastes with inconsistent particle diameters is generated inside the mariculture cabin 11, small-particle wastes are discharged into the sea water through the meshes of the fine filter screen under the action of gravity, and large-particle wastes settle to the annular sewage sump 4 at the bottom through the coarse screen.

In the present embodiment, the bottom inclination of the mariculture cabin 11 is 3° to 7°. The annular sewage sump 4 is communicated with a sewage pipeline 5. The sewage pipeline 5 is connected in series with a conveying pump 7. The tail end of the sewage pipeline 5 is connected to a solid-liquid separator 8. The solid-liquid separator 8 is provided with a solid outlet 9 and a liquid outlet 10. When the conveying pump 7 works, the large-particle wastes enter the solid-liquid separator 8 through the sewage pipeline 5, solid waste in liquid settles, and thus solid-liquid separation occurs under the centrifugal force generated by the high-speed rotation of a rotary drum. The separated solid waste is discharged from the solid outlet 9, and water is discharged from the liquid outlet 10.

In order to prevent the rise in pressure of the sewage system caused by untimely solid-liquid separation, an overflow pipe 6 is provided at an inlet of the solid-liquid separator 8, and the overflow pipe 6 is communicated with the annular sewage sump 4, so as to ensure the safety of the system.

According to the controllable semi-open mariculture cabin system in the present disclosure, the gate valve 12 is controlled electrically or manually, the conveying pump 7 is driven by a motor, and the solid-liquid separator 8 is driven by a motor.

According to the controllable semi-open mariculture cabin system in the present disclosure, the flow field inside the mariculture cabin 11 is controllable, and there is no need for a water circulating and water treatment system. The mariculture cabin 11 is of a semi-open structure, with the bottom communicated with sea water, and has the following advantages that discharge of the waste is controllable, the environmental pollution is reduced, and the separated solid waste can be used to produce an organic manure. The mariculture cabin system 11 can improve the mariculture level, expand the utilization rate of deep sea mariculture space, and play an exemplary role in developing a deep sea mariculture mode.

For those skilled in the art, it is obvious that the present disclosure is not limited to the details of the above exemplary embodiments and can be implemented in other specific forms without departing from the spirit or basic features of the present disclosure. Therefore, from any point of view, the embodiments should be regarded as exemplary but not restrictive. The scope of the present disclosure is limited by the attached claims rather than the above description. Therefore, it is intended to include all changes within the meaning and scope of the equivalent elements of the claims in the present disclosure, and any numeral in the claims shall not be regarded as limiting the claims involved.

In the present disclosure, specific examples are applied to illustrate the principle and implementation manner of the present disclosure. The description of the above embodiment is only used to help understand the method and core idea of the present disclosure. Meanwhile, for those of ordinary skill in the art, there will be changes in the specific implementation manner and scope of application according to the idea of the present disclosure. In conclusion, the content of the present description shall not be construed as a limitation to the present disclosure.

What is claimed is:

1. A controllable semi-open mariculture cabin system, comprising a mariculture cabin, a water inlet mechanism, a filtering mechanism, and a fish outlet pipe, wherein the water inlet mechanism comprises a water inlet pipe and a plurality of high-pressure water inlet pipes; the water inlet pipe is located on one side of an upper part of the mariculture cabin; the plurality of high-pressure water inlet pipes are distributed in a circumferential direction of a top of the mariculture cabin; tail ends of the high-pressure water inlet pipes are connected to jet pipes extending into the mariculture cabin; the filtering mechanism is arranged at a bottom of the mariculture cabin; an outlet end of the filtering mechanism is located in sea water outside; the fish outlet pipe is provided on a cabin wall of the mariculture cabin; and a gate valve capable of opening and closing is mounted on the fish outlet pipe.

2. The controllable semi-open mariculture cabin system according to claim 1, wherein a water pump is provided on the water inlet pipe, and the water pump is used for pumping a water source.

3. The controllable semi-open mariculture cabin system according to claim 1, wherein water pumps are also mounted on the high-pressure water inlet pipes; the jet pipes are arranged downward vertically along an inner wall of the mariculture cabin; and jet holes are uniformly distributed in the jet pipes.

4. The controllable semi-open mariculture cabin system according to claim 1, wherein the filtering mechanism comprises a frustoconical fine filter screen and an annular sewage sump; the annular sewage sump is provided in an outer circumference of a bottom of the frustoconical fine filter screen; and a sewage outlet of the annular sewage sump is communicated with a sewage pipeline.

5. The controllable semi-open mariculture cabin system according to claim 4, wherein a coarse filter screen is mounted at an opening of an upper part of the annular sewage sump; and a filtering diameter of the coarse filter screen is greater than that of the frustoconical fine filter screen.

6. The controllable semi-open mariculture cabin system according to claim 4, wherein a tail end of the sewage pipeline extends out of the mariculture cabin and is connected to a solid-liquid separator; and a conveying pump is provided on the sewage pipeline.

7. The controllable semi-open mariculture cabin system according to claim 6, wherein the solid-liquid separator is provided with a solid outlet and a liquid outlet; and separated solid waste is discharged from the solid outlet, and water is discharged from the liquid outlet.

8. The controllable semi-open mariculture cabin system according to claim 6, wherein an overflow pipe is provided at an inlet of the solid-liquid separator, and an outlet of the overflow pipe is communicated with the annular sewage sump.
